(19) United States
(12) Patent Application Publication
(10) Pub. No.: US 2010/0110246 A1
(43) Pub. Date: May 6, 2010

(54) Image sensor and method of manufacturing the same

(75) Inventor: Yun Ki Lee, Seoul (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/585,731

(22) Filed: Sep. 23, 2009

(30) Foreign Application Priority Data
Nov. 3, 2008 (KR) 10-2008-0108385

(51) Int. Cl. H04N 5/335

(52) U.S. Cl. 348/294; 348/E05.022

(57) ABSTRACT

Provided is an image sensor. The image sensor according to example embodiments may include a substrate having an effective pixel region and an ineffective pixel region adjacent to the effective pixel region. The substrate may also have a shading pattern over the ineffective pixel region of the substrate. The shading pattern includes one or more openings to allow hydrogen ions to pass therethrough but prevent incident light from penetrating to the ineffective pixel region.

### PRIORITY STATEMENT

This U.S. non-provisional patent application claims priority under 35 U.S.C. §119 to Korean Patent Application No. 10-2008-0108385, in the Korean Intellectual Property Office (KIPO) filed on Nov. 3, 2008, the entire contents of which are herein incorporated by reference .

### BACKGROUND

The example embodiments disclosed herein relate to semiconductor devices, and more particularly, to an image sensor and a method of manufacturing the same.

An image sensor is a semiconductor device converting an optical image into an electric signal. An image sensor can be divided into a charge coupled device (CCD) and a CMOS image sensor (CIS).

The CCD includes MOS capacitors disposed to be adjacent to each other. The CCD is a device that a charge carrier is stored and moved by the capacitors. The CIS includes MOS transistors of as much as the number of pixels. The CIS is a device using a switching method sequentially detecting an output using the MOS transistors.

The image sensors include a shading layer for preventing a light from inputting in a specified region. The shading layer is formed of metal material and is disposed at a region which does not detect a light except upper portions of photodetectors.

### SUMMARY

Example embodiments provide an image sensor. The image sensor may include a substrate including an effective pixel region and an ineffective pixel region adjacent to the effective pixel region and a shading pattern over the ineffective pixel region of the substrate. The shading pattern includes one or more openings configured to prevent an incident light from penetrating to the ineffective pixel region. The openings have a dimension through which incident light does not pass. The openings are also configured to pass hydrogen ions.

### BRIEF DESCRIPTION OF THE FIGURES

Example embodiments will be more clearly understood from the following brief description taken in conjunction with the accompanying drawings. FIGS. 1-9 represent non-limiting, example embodiments as described herein.

FIG. 1 is a circuit diagram depicting a portion of an active pixel sensor (APS) of an image sensor according to example embodiments .

FIG. 2 is a drawing illustrating an image sensor according to example embodiments.

FIGS. 3A and 3B are top plan views illustrating various examples of a shading layer pattern depicted in FIG. 1.

FIG. 4 is a graph representing a transmittance of a light according to a wavelength of a light.

FIG. 5 is a graph representing a width of an opening of a shading layer pattern according to a wavelength of a light and a refractive index of an interlayer insulating layer.

FIG. 6 is a flowchart illustrating a process of manufacture of an image sensor according to example embodiments.

FIG. 7 is a drawing illustrating an image sensor according to an example embodiment.

FIG. 8 is a drawing illustrating an image sensor according to an example embodiment.

FIG. 9 is a drawing illustrating an image sensor according to an example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Example embodiments will be described more fully hereinafter with reference to the accompanying drawings, in which example embodiments are shown. Example embodiments may, however, be embodied in many different forms and should not be construed as limited to the example embodiments set forth herein. Rather, these example embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Example embodiments may be described with reference to cross-sectional illustrations, which are schematic illustrations of idealized example embodiments . As such, variations from the shapes of the illustrations, as a result, for example, of manufacturing techniques and/or tolerances, are to be expected. Thus, embodiments of the present invention should not be construed as limited to the particular shapes of regions illustrated herein, but are to include deviations in shapes that result from, e.g., manufacturing. For example, a region illustrated as a rectangle may have rounded or curved features. Thus, the regions illustrated in the figures are schematic in nature and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

In the drawings, the thickness of layers and regions are exaggerated for clarity. It will also be understood that when an element such as a layer, region or substrate is referred to as being “on” or “onto” another element, it may lie directly on the other element or intervening elements or layers may also be present. Like reference numerals refer to like elements throughout the specification.

Spatially relatively terms, such as “beneath,” “below,” “above,” “upper,” “top,” “bottom” and the like, may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, when the device in the figures is turned over, elements described as below and/or beneath other elements or features would then be oriented (rotated 90 degrees or at other orientations) and the spatially relative descriptors used herein interpreted accordingly. As used herein, “height” refers to a direction that is generally orthogonal to the faces of a substrate.

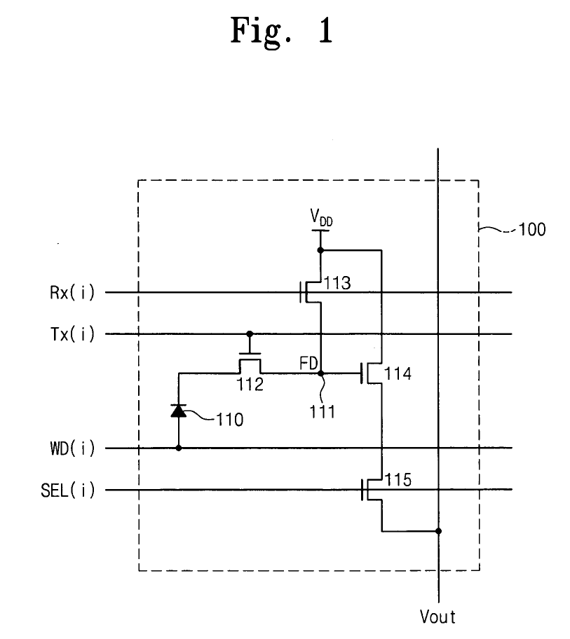

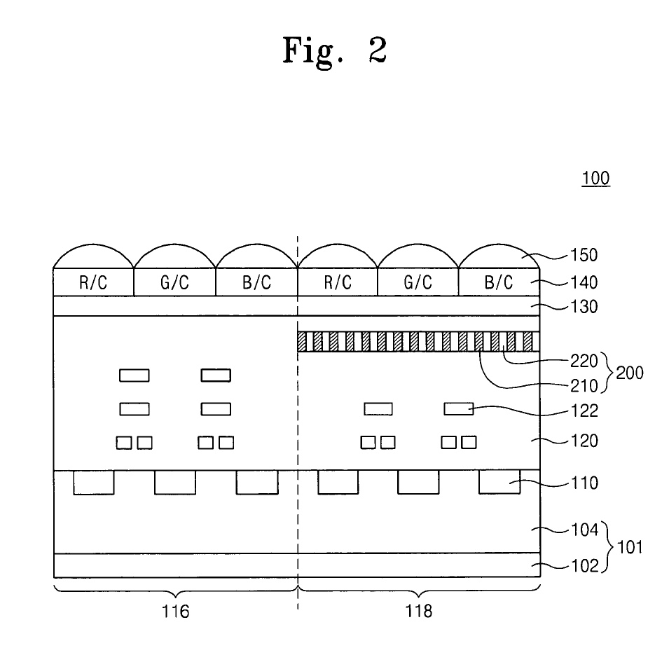

Referring to FIGS. 1 and 2, an image sensor 100 in accordance with example embodiments may include a semiconductor device converting an image into an electric signal. For example, the image sensor 100 may be a CMOS image sensor (CIS). The image sensor 100 may include an active pixel sensor (APS) array region on which pixels are disposed and a logic region (not shown) controlling the APS array region.

The APS array region may be driven by receiving various drive signals such as a pixel select signal (SEL(i)), a reset signal (RX(i)) and a charge transmitting signal (TX(i)) from a row driver (not shown). A plurality of pixels may be two dimensional in the APS array region. Each of the pixels may include a photodetector 110, a detector 111 receiving charges accumulated in the photodetector and then storing the charges, a charge transfer device 112 transferring the charges accumulated in the photodetector 110 to the detector 111 and a readout device reading an optical signal input to the photodetector 110.

If the charge transfer device 112 transfers charges, a well driving signal (WD(i)) for lowering a potential of around the photodetector 110 may be provided. The readout device may include at least one transistor. For example, the readout device may include a reset transistor 113, a drive transistor 114 and a select transistor 115. The reset transistor 113 can periodically reset the detector 111. A source of the reset transistor 113 is connected to the detector 111 and a drain of the reset transistor 113 is connected to a voltage (V_{DD}). The drive transistor 114 may amplify a change of an electric potential of the detector 111 and may output the change to an output line (Vout). The select transistor 115 selects a unit pixel to be readout by a row unit.

The image sensor 100 may include a substrate 101. The substrate 101 may include an epitaxial layer 104 on a bulk substrate 102. The substrate 101 may include an effective pixel region 116 and an ineffective pixel region 118. The ineffective pixel region 118 may be provided to detect an optical black.

The photodetector 110 may be on the substrate 101. The photodetector 110 may generate and accumulate charges corresponding to an incident light. The photodetector 110 may include any one of a photodiode, a phototransistor, a photo gate and a pinned photodiode. For example, the photodetector 110 may have a structure including photodiodes having different conductivity types from each other are stacked in the epitaxial layer 104. The detector 111 may be spaced apart from the photodetector 110 in the epitaxial layer 104. The readout device may be on the substrate 101.

An interlayer insulating layer 120 may be on the substrate 101. Interconnections 122 may be in the interlayer insulating layer 120. The interconnections 122 may be electrically connected to the transistors. A hydrogen supply layer 130 may be on the interconnections 122. The hydrogen supply layer 130 may include material including a large amount of hydrogen. For example, the hydrogen supply layer 130 may include any one of a silicon nitride layer and a silicon oxynitride layer. A color filter 140 may be on the hydrogen supply layer 130. The color filter 140 may include a red color filter (R/C), a green color filter (G/C) and a blue color filter (B/C). A microlens 150 may be on the color filter 140. The microlens 150 may correspond to the red color filter (RIC), the green color filter (G/C) and the blue color filter (B/C).

A shading member 200 may be on the ineffective pixel region 118 between the substrate 101 and the hydrogen supply layer 130. The shading member 200 may prevent an incident light from moving to the ineffective region 118. In addition, the shading member 200 may be used as a path through which hydrogen ions move from the hydrogen supply layer 130 to the substrate 101 when a hydrogen annealing process is performed. For example, the shading member 200 may include a shading pattern 210 having openings 220. The shading pattern 210 may be on the interlayer insulating layer 120.

The shading pattern 210 may cover an entire surface of the ineffective pixel region 118. The shading pattern 210 may be a metal. For example, the shading pattern 210 may include at least one among titanium, tungsten, a tungsten nitride layer, tungsten titanium, nickel, aluminum and copper. The shading pattern 210 may be used as an interconnection electrically connected to at least one among the transistors 113, 114 and 115. The openings 220 may be provided to have various shapes to the shading pattern 210.

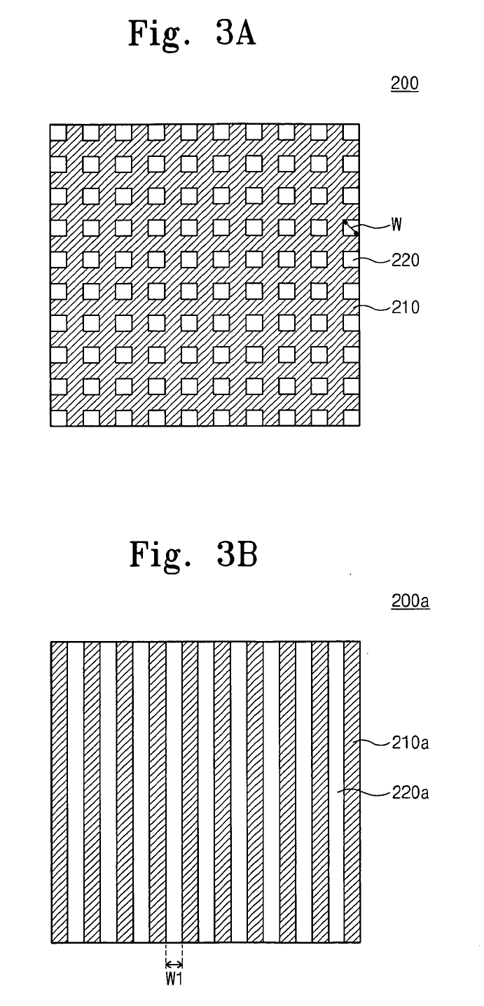

Referring to FIG. 3A, the shading member 200 may include the shading pattern 210 having the openings 220 of a shape of a plurality of islands. For example, the openings 220 may have a square shape. The openings 220 may be spaced a uniform distance apart from each other in the shading pattern 210. A width (W) of the openings 220 may be controlled so that an incident light is shaded while a movement of hydrogen ions is allowed. If a wavelength of an incident light is λ, a maximum width (W: a distance between corners facing each other) of the openings 220 may be controlled at less than about λ/2. Because an incident light having a wavelength of λ cannot pass through the openings 220, the incident light may be shaded by the shading pattern 210.

Also, as the openings 220 are controlled so as to allow a diffusion of hydrogen ions as much as possible, an efficiency of hydrogen diffusion of an annealing process which will be described later may be maximized. Thus, the width (W) of the openings 220 may be controlled to have a maximum width (e.g., λ/2) capable of shading an incident light. The openings 220 may have a round shape. If the opening 220 have a round shape, a diameter of the openings 220 may be controlled at less than about λ/2.

Referring to FIG. 3B, for example, a shading member 200a may include a shading pattern 210a having openings 220a of a line shape. If the openings 220a have a line shape, the incident light may be provided to polarize in a direction perpendicular to a lengthwise direction of the openings 220a. A polarizing member (not shown) capable of polarizing the incident light such as a polarizing filter may be on the shading member 200a. The openings 220a may be parallel to each other at a regular interval in the shading pattern 210a.

In addition, the openings 220a may be perpendicular to a vibration direction of a polarized incident light. A width (W1) of the openings 220a may be controlled so that an incident light may be shaded while a movement of hydrogen ions is allowed. If a wavelength of an incident light is λ, the width (W1) of the openings 220a may be controlled at less than about λ/2. Because an incident light having a wavelength of λ cannot pass through the openings 220a, the incident light may be shaded by the shading pattern 210. As the openings 220a are controlled so as to allow a diffusion of hydrogen ions as much as possible, an efficiency of hydrogen diffusion of an annealing process, which will be described later, may be maximized. Thus, the width (W1) of the openings 220a may be controlled to have a maximum width (e.g., λ/2) capable of shading an incident light.

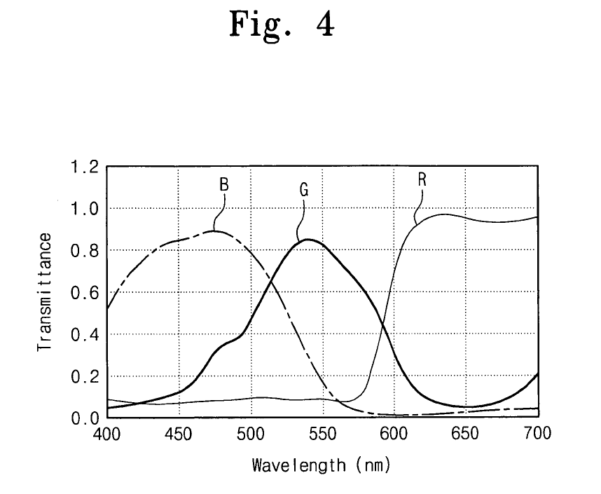

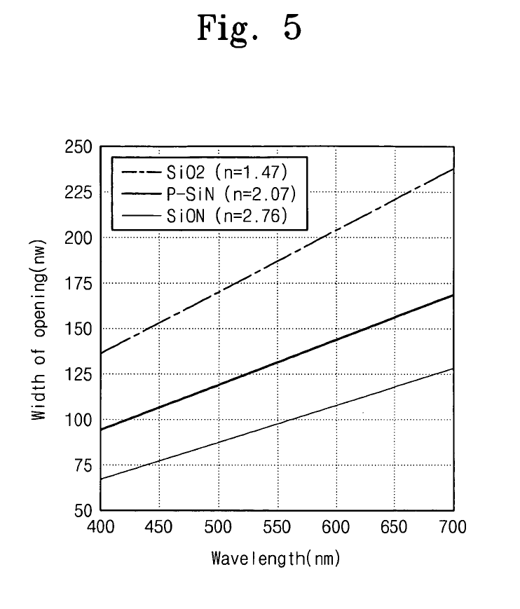

Referring to FIGS. 1 through 5, the width (W, W1) of the opening (220, 220a) may be controlled by a refractive index of the interlayer insulating layer 120 between the substrate 101 and the hydrogen supply layer 130. For example, if the interlayer insulating layer 120 is a silicon oxide layer (e.g., SiO₂) and shades an incident light having a wavelength of more than about 600 nm, a red light (R) has a wavelength of about 600 nm, see FIG. 4, and a silicon oxide layer may have a refractive index of about 1.47, see FIG. 5. A wavelength of the red light (R) may be reduced to about 400 nm (600 nm/1.47) while the red light (R) passes through the silicon oxide layer.

Thus, if the interlayer insulating layer is a silicon oxide layer and a width (W, W1) of the opening (220, 220a) is controlled at less than about 200 nm (400 nm/2), the red light (R) may be shaded by the opening (200, 200a). For example, when the interlayer insulating layer 120 is a silicon nitride layer (SiN) and the width (W, W1) is controlled less than about 145 nm (600 nm/(2.07×2)), the red light (R) may be shaded by the opening 220. For example, when the interlayer insulating layer 120 is a silicon oxynitride layer (SiON) and the width (W, W1) is controlled less than about 109 nm (600 mm (2.76×2)), the red light (R) may be shaded by the opening 220.

In a manner similar to the manner described above, when an incident light is a green light (G) and a blue light (B), the width (W, W1) of the opening 220 may be controlled by considering a refractive index of the interlayer insulating layer 120. For example, a wavelength of the green light (G) is about 550 nm and a wavelength of the blue light (B) is about 450 nm. Thus, when shading an incident light having a wavelength of more than about 550 nm, the width (W, W1) may be controlled less than about half of a value that a wavelength of the green light (G) is divided by a refractive index (n) of the interlayer insulating layer 120. When shading an incident light having a wavelength of about more than about 450 nm, the width (W, W1) may be controlled less than half of a value that a wavelength of the blue light (B) is divided by a refractive index (n) of the interlayer insulating layer 120.

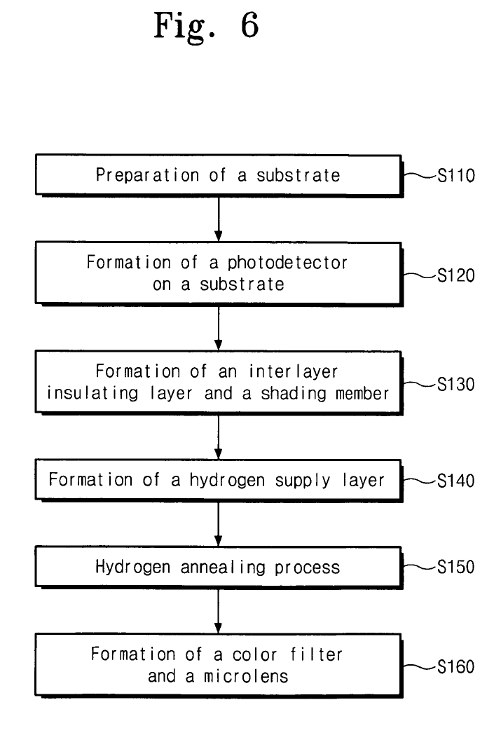

A process of manufacturing an image sensor according to example embodiments is described in detail. The description of common features already described with respect to the image sensor 100 according to example embodiments may be omitted or simplified. FIG. 6 is a flowchart illustrating a process of manufacture of an image sensor according to example embodiments.

Referring to FIGS. 2 and 6, a substrate 101 may be prepared (S110). For example, an epitaxial layer 104 may be on a bulk substrate 102. Forming the epitaxial layer 104 may include a process of implanting an impurity ion into the substrate 101.

An electric device may be on the substrate 101 (S120). For example, a photodetector 110 may be on the epitaxial layer 104. The photodetector 110 may be formed by performing ion implantation processes having different amounts of energy on the epitaxial layer 104. Transistors (not shown) may be on the substrate 101.

An interlayer insulating layer 120 and a shading member 200 may be formed (S130). For example, the interlayer insulating layer 120 may be on the substrate 101. The interlayer insulating layer 120 may include a plurality of sequential interlayer insulating layers on the substrate 101. The interlayer insulating layer 120 may be any one material of a silicon oxide layer, a silicon nitride layer and a silicon oxynitirde layer. The shading member 200 may be on the interlayer insulating layer 120. Forming the shading member 200 may include forming a metal layer on the interlayer insulating layer 120 and forming an opening on the metal layer by patterning the metal layer. As a result, a shading pattern having an opening 220 may be formed on the interlayer insulating layer 120.

A hydrogen supply layer 130 may be formed (S140). The hydrogen supply layer 130 may be of a material containing a large quantity of hydrogen. Forming the hydrogen supply layer 130 may include at least one of a silicon oxide layer, a silicon nitride layer and a silicon oxynitride layer on the interlayer insulating layer 120.

A hydrogen annealing process may be performed on a resultant structure where the hydrogen supply layer 130 may be formed (S150). Thus, a hydrogen ion may be diffused from the hydrogen supply layer 130 into the substrate 101. An interface energy level by a dangling bond in the image sensor 100 may be reduced due to a diffusion of the hydrogen ion. The opening 220 may be provided so as to pass the hydrogen ion. Thus, when the hydrogen annealing process is performed, the hydrogen ion may also move from the hydrogen supply layer 130 to the substrate 101 through the opening 220.

A color filter 140 and a microlens 150 may be formed (S160). The color filter 140 may include a red color filter (R/C), a green color filter (G/C) and a blue color filter (B/C) on an effective pixel region 116 and an ineffective pixel region 118. The microlens 150 may correspond to the red color filter (R/C), the green color filter (G/C) and the blue color filter (B/C).

As described above, the image sensor 100 according to an example embodiment may include the shading member 200 having an opening 220 which shades a light and allow a diffusion of a hydrogen ion at the same time. Thus, when the hydrogen annealing process is performed, example embodiments may prevent a diffusion of a hydrogen ion from being blocked and can improve an efficiency of the hydrogen annealing process using the shading member 200.

Hereinafter, image sensors according to example embodiments are described in detail. The description of common features already described with respect to the image sensor 100 according to an example embodiment may be omitted or simplified. Also, a manufacturing process of image sensors according to the example embodiments is omitted because one of ordinary skill in the art can fully understand the manufacturing process of image sensors according to the example embodiments of the present invention through the manufacturing process of the image sensor according to an example embodiment.

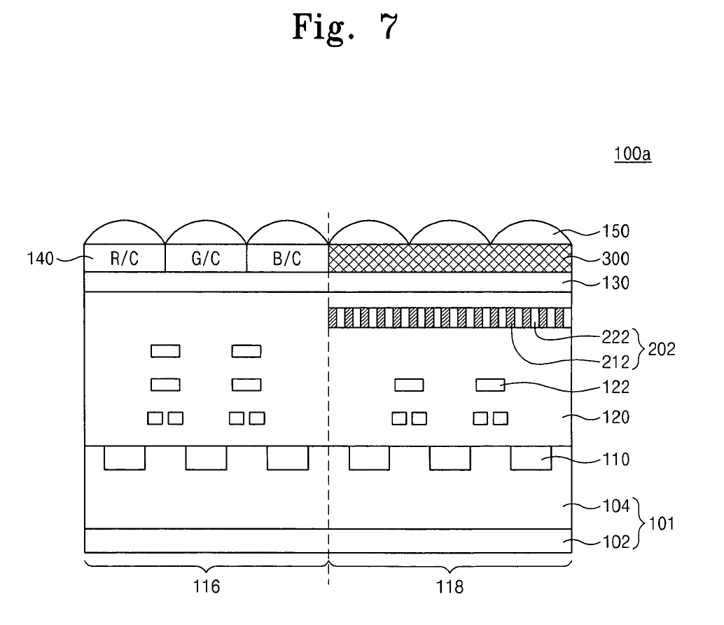

FIG. 7 is a drawing illustrating an image sensor 100a according to an example embodiment. Referring to FIG. 7, the image sensor 100a according to an example embodiment may include a second shading member 300 compared with the image sensor 100 described referring to FIG. 1. For example, the image sensor 100a may include a substrate 101 including an effective pixel region 116 and an ineffective pixel region 118, a first shading member 202 on the substrate 101 and the second shading member 300 on the first shading member 202.

The substrate 101 may include an epitaxial layer 104 on a bulk substrate 102. A photodetector 110 may be on the substrate 101. In addition, a plurality of transistors (not shown) may be on the substrate 101. An interlayer insulating layer 120 may be on the substrate 101. An interconnection 122 electrically connected to the transistors may be in the interlayer insulating layer 120. A hydrogen supply layer 130 may be on the interlayer insulating layer 120. Color filters 140 may be on the hydrogen supply layer 130 located on the effective pixel region 116. A microlens 150 may be on the color filters 140 and the second shading member 300.

The first shading member 202 may be on the ineffective pixel region 118 between the substrate 101 and the hydrogen supply layer 130. The first shading member 202 may have a similar structure to the shading member 200 described referring to FIGS. 1 through 2C. The first shading member 202 may include a shading pattern 212 including an opening 222. A width of the opening 222 may be controlled so as to shade a light and allow a diffusion of hydrogen.

The second shading member 300 may be on the hydrogen supply layer 130 of the ineffective pixel region 118. The second shading member 300 may be used as an auxiliary shading member assisting a shading function of the first shading member 202. For example, the second shading member 300 may include at least one color filter. The color filter may cover an entire surface of the interlayer insulating layer 120 of the ineffective pixel region 118. The color filter may include any one of a red color filter, a green color filter and a blue color filter. Because the color filters have an own refractive index, a wavelength of a light passing through the color filters may be reduced. Thus, the second shading member 300 may prevent an incident light from moving to the substrate 101 and a width of the opening 220 of the first shading member 200 may be controlled by considering a refractive index of the second shading member 300.

The image sensor 100a described above may include the second shading member 300 assisting a shading function of the first shading member 202 compared with the image sensor 100 according to an example embodiment.

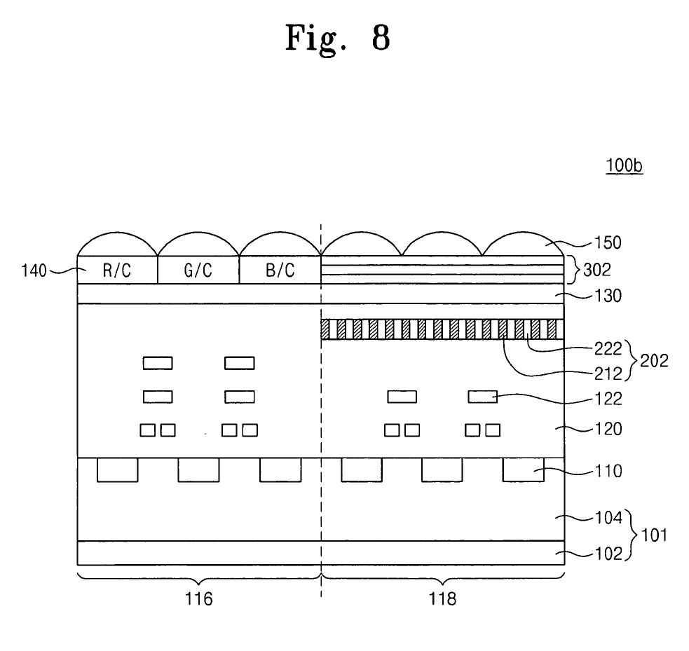

FIG. 8 is a drawing illustrating an image sensor 100b according to an example embodiment. The image sensor 100b according to an example embodiment may include a second shading member 302 where a plurality of color filters are stacked compared with the image sensor 100 described referring to FIG. 1. For example, the image sensor 100b may include a substrate 101 including an effective pixel region 116 and an ineffective pixel region 118, a first shading member 202 on the substrate 101 and a second shading member 302 on the first shading member 202.

The substrate 101 may include an epitaxial layer 104 on a bulk substrate 102. A photodetector 110 may be on the substrate 101. In addition, a plurality of transistors (not shown) may be on the substrate 101.

An interlayer insulating layer 120 may be on the substrate 101. An interconnection 122 electrically connected to the transistors may be in the interlayer insulating layer 120. A hydrogen supply layer 130 may be on the interlayer insulating layer 120. Color filters 140 may be on the hydrogen supply layer 130 of the effective pixel region 116. A microlens 150 may be on the color filters 140 and the second shading member 302.

The first shading member 202 may be on the ineffective pixel region 118 between the substrate 101 and the hydrogen supply layer 130. The first shading member 202 may have a similar structure to the shading member 200 described referring to FIGS. 1 through 2C. The first shading member 202 may include a shading pattern 212 including an opening 222. A width of the opening 222 may be controlled so as to shade a light and allow a diffusion of hydrogen.

The second shading member 302 may assist a shading function of the first shading member 202. The second shading member 302 may include a color filter laminated structure. The color filter laminated structure may be on the hydrogen supply layer 130 located on the ineffective pixel region 118. The color filter laminated structure may cover an entire surface of the ineffective pixel region 118. The color filter laminated structure may have a structure in which a plurality of stacked color filters. For example, the color filter laminated structure may have a structure in which color filters of more than two of a red color filter, a green color filter and a blue color filter are stacked. Using the structure described above in which color filters of more than two are stacked as an auxiliary shading layer can increase a shading efficiency of the an auxiliary shading layer compared with a structure using one color filter as an auxiliary shading layer.

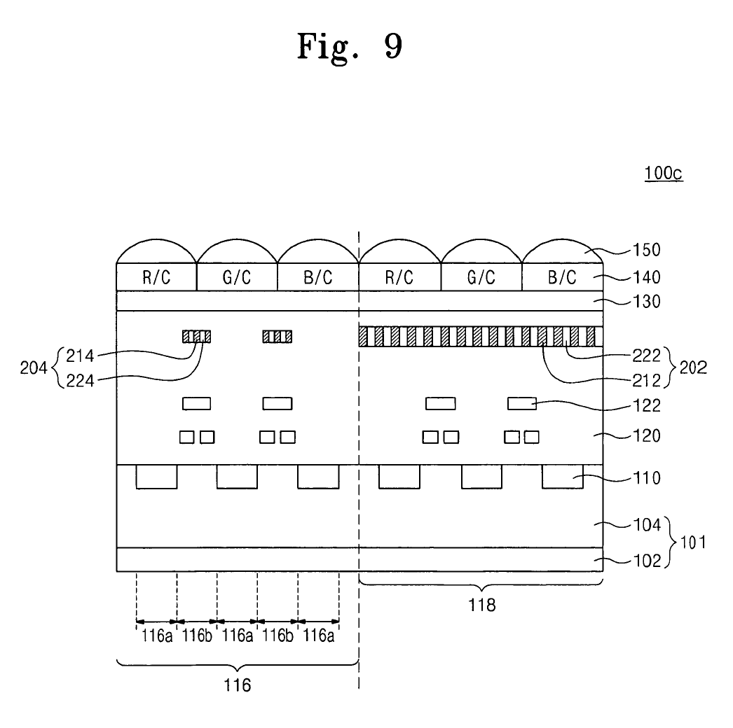

FIG. 9 is a drawing illustrating an image sensor 100c according to an example embodiment. The image sensor 100c according to an example embodiment may include a second shading member 204 on an effective pixel region compared with the image sensor 100 described referring to FIG. 1. For example, the image sensor 100c may include a substrate 101 including an effective pixel region 116 and an ineffective pixel region 118, a first shading member 202 on the ineffective pixel region 118 and a second shading member 204 on the effective pixel region 116.

The substrate 101 may include an epitaxial layer 104 on a bulk substrate 102. A photodetector 110 may be on the substrate 101. In addition, a plurality of transistors (not shown) may be on the substrate 101. The effective pixel region 116 may include a region 116a detecting a light and a region 116b which does not detect a light. The region 116a detecting a light may be a region of the photodetector 110 of the substrate 101 and the region 116b which does not detect a light may be a peripheral region of the region 116a. The transistors may be on the region 116b which does not detect a light.

An interlayer insulating layer 120 may be on the substrate 101. An interconnection 122 may be in the interlayer insulating layer 120. A hydrogen supply layer 130 may be on the interlayer insulating layer 120. Color filters 140 may be on the hydrogen supply layer 130. A microlens 150 may be on the color filters 140.

The first shading member 202 may be on the ineffective pixel region 118 between the substrate 101 and the hydrogen supply layer 130. The first shading member 202 may have a similar structure to the shading member 200 described referring to FIGS. 1 through 2C. The first shading member 202 may include a shading pattern 212 including an opening 222. A width of the opening 222 may be controlled so as to shade a light and allow a diffusion of hydrogen at the same time.

The second shading member 204 may be on the region 116b of the effective pixel region 116 between the hydrogen supply layer 130 and the substrate 101. The second shading member 204 may include a similar structure to the shading member 200 described referring to FIGS. 1 through 2C. The second shading member 204 may include a shading pattern 214 having an opening 224. The opening 224 may prevent an incident light from moving to the region 116b which does not detect a light.

The image sensor 100c according to an example embodiment may include the first shading member 202 preventing an incident light from moving to the ineffective pixel region 118 and the second shading member 204 preventing an incident light from moving to the region 116b of the effective pixel region 116.

The foregoing is illustrative of example embodiments and is not to be construed as limiting thereof. Although example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. It will be understood by one of ordinary skill in the art that variations in form and detail may be made therein without departing from the spirit and scope of the claims. The present invention is defined by the following claims, with equivalents of the claims to be included therein.

What is claimed is:

1. An image sensor comprising:
a substrate including an effective pixel region and an ineffective pixel region adjacent to the effective pixel region; and
a first shading pattern over the ineffective pixel region of the substrate, the first shading pattern including one or more openings configured to prevent an incident light from penetrating to the ineffective pixel region.

2. The image sensor of claim 1, wherein the openings have a dimension through which the incident light does not pass.

3. The image sensor of claim 2, wherein the dimension is less than half of a wavelength of the incident light.

4. The image sensor of claim 2, wherein the openings are configured to pass hydrogen ions.

5. The image sensor of claim 1, further comprising:
an insulating layer at least one of over an upper portion of the first shading pattern and under a lower portion of the first shading pattern, wherein a dimension of the openings is based on a refractive index of the insulating layer and a wavelength of the incident light.

6. The image sensor of claim 5, wherein the dimension is less than one half of the refractive index divided by the wavelength.

7. The image sensor of claim 1, further comprising:
a second shading pattern over the first shading pattern, the second shading pattern configured to assist a shading function of the first shading pattern, wherein the second shading pattern includes a color filter.

8. The image sensor of claim 7, further comprising:
an auxiliary shading layer over the first shading pattern, the auxiliary shading layer configured to assist a shading function of the second shading pattern, wherein the second shading pattern includes a color filter laminated structure having a plurality of stacked color filters.

9. The image sensor of claim 1, wherein
the effective pixel region includes one or more first regions configured to detect a light, one or more second regions configured to not detect the light and one or more photodetectors, and
the first shading pattern is over the one or more second regions.

10. The image sensor of claim 9, wherein the first shading pattern over the one or more second regions is an island over an insulating layer of the effective pixel region.

11. The image sensor of claim 1, wherein
the first shading pattern includes a plurality of lines in parallel to each other and spaced apart from each other such that an opening of the one or more openings exists between two lines of the plurality of lines, and
a lengthwise direction of the plurality of lines is perpendicular to a vibration direction of the polarized incident light.

12. The image sensor of claim 1, further comprising:
a transistor configured to perform an operation of a photodetector, wherein the first shading pattern includes an interconnection electrically connected to the transistor.

13. The image sensor of claim 1, further comprising:
a hydrogen supply layer over the first shading pattern;
a plurality of color filters, over the hydrogen supply layer configured to selectively filter light of differing colors; and
a plurality of microlenses each associated with a separate color filter of the plurality of color filters, the plurality of microlenses configured to direct light to the plurality of color filters, wherein the openings are configured to pass hydrogen ions from the hydrogen supply layer to the substrate.

14. The image sensor of claim 13, wherein the plurality of color filters are stacked one on top of another and are configured as a second shading pattern.

15. The image sensor of claim 1, wherein
the effective pixel region is configured to detect a light, and
the ineffective pixel region is configured to detect an optical black.

16. An image sensor comprising:
a substrate; and
a shading pattern over a portion of the substrate, the shading pattern including one or more openings configured to allow hydrogen ions to pass therethrough but prevent incident light from penetrating to the substrate.

17. The image sensor of claim 16, wherein the openings have a dimension that is less than half of a wavelength of the incident light.

18. The image sensor of claim 16, further comprising:
an insulating layer at least one of over an upper portion of the shading pattern and under a lower portion of the shading pattern, wherein a dimension of the openings is based on a refractive index of the insulating layer and a wavelength of the incident light.

19. The image sensor of claim 16, wherein the portion of the substrate includes an ineffective pixel region having one or more photodetectors configured to detect an optical black.

20. The image sensor of claim 16, further comprising:
a hydrogen supply layer over the shading pattern;
a plurality of color filters, over the hydrogen supply layer configured to selectively filter light of differing colors; and
a plurality of microlenses each associated with a separate color filter of the plurality of color filters, the plurality of microlenses configured to direct light to the plurality of color filters.
